(19) United States
(12) Patent Application Publication
(10) Pub. No.: US 2023/0056438 A1
(43) Pub. Date: Feb. 23, 2023

(54) Grill Mounting Device

(71) Applicant: Donald Marquez, Henderson, NV (US)

(72) Inventor: Donald Marquez, Henderson, NV (US)

(21) Appl. No.: 17/889,038

(22) Filed: Aug. 16, 2022

Related U.S. Application Data
(60) Provisional application No. 63/233,822, filed on Aug. 17, 2021.

(51) Int. Cl. A47J 37/07; B60R 11/00

(52) U.S. Cl. CPC A47J 37/0786; B60R 11/00; B60R 2011/0052

(57) ABSTRACT

The present invention relates to a grill mount device that allows a wood pellet, charcoal, gas or electrical grill to be mounted to a boat, RV or vehicle. The device has a body with at least one side extension, having an opening that can receive a grease trap and a cutout that can receive a power cord of the grill. The side extension also has a shelf holds magnetic containers. The bottom surface is connected to a mounting arm that allows the body to be attached to a boat, RV or vehicle. A movable preparation tray or working surface is hingedly-connected to the body and is movable from a first position to a second position.

### CROSS-REFERENCE TO RELATED APPLICATION

The present application claims priority to, and the benefit of, U.S. Provisional Application No. 63/233,822, which was filed on Aug. 17, 2021, and is incorporated herein by reference in its entirety.

### FIELD OF THE INVENTION

The present invention relates generally to the field of consumer accessories for outdoor cooking kitchens and grills. More specifically, the present invention relates to a grill mount device that allows a wood pellet, charcoal, gas or electrical grill to be mounted to a boat, watercraft or other recreational vehicle. The accessory device is primarily comprised of a body having a top surface with a continuous opening that can receive a grease trap for a pellet, charcoal, gas or electric grill, a cutout that can receive a power cord for the grill and a tray that houses one or more magnetic containers. The bottom surface of the grill body further includes at least one opening that allows for a mounting structure to attach to the bottom surface in order to connect the device to a boat, other watercraft or recreational vehicle. The mounting assembly includes at least one hinge that secures a movable preparation tray or working surface to the assembly. Any surface of the body may further include at least one protrusion that allows a user to hang cookware or utensils from the body of the grill and/or the mounting assembly. Accordingly, the present disclosure makes specific reference thereto. Nonetheless, it is to be appreciated that aspects of the present invention are also equally applicable to other like applications, devices and methods of manufacture.

### BACKGROUND

Many individuals who own boats, watercraft or recreational vehicles that enjoy boating and other recreational activities, often also enjoying grilling while being outdoors or on the water. However, because boats are unstable while in the water due to waves or the like, and recreational vehicles (RV) can rock in the wind or while people egress into or out of the RV or during tailgating at a sporting event, a grill must be mounted to some portion of the boat or RV to ensure the grill does not tip or potentially fall out of the boat while the boat is in motion or idling on the water or off the RV onto the ground, potentially causing a fire. Further, a majority of grill mounts known in the art are specifically designed for grills that are powered by gas or propane. However, some individuals may prefer to cook with an electric, charcoal or a wood pellet grill while boating or being outdoors. In addition, many individuals utilize seasonings, spices, rubs, sauces and various other ingredients or treatments while cooking or otherwise preparing foods. However, there are normally no secure places to store containers while on a boat or RV, especially while a boat or RV is in motion. To this effect, seasonings, spices, rubs, sauces and various other ingredients or treatments or combinations thereof may tip or potentially fall out of a boat or RV while the boat or RV is in motion, or when a boat is idling on the water. In addition, boats offer little workspace or flat surfaces to cut, trim and prepare various meats, fish and other foods for grilling, and RV's may not have available outdoor work areas.

Therefore, there exists a long-felt need in the art for an improved grill mount. There also exists a long-felt need in the art for a grill mount device that allows a user to easily mount an electric, charcoal or wood pellet grill to a boat, vehicle or RV. Further, there exists a long-felt need in the art for a grill mount device that securely retains seasonings, spices, rubs, sauces and various other ingredients or treatments while grilling on a boat, RV or SUV. Finally, there exists a long-felt need in the art for a grill mount device that provides a workspace to allow a user to cut, trim and prepare food for grilling.

The subject matter disclosed and claimed herein, in one embodiment thereof, comprises a grill mount device that allows a wood pellet, charcoal or electrical grill to be mounted to a boat, RV or SUV. The device has a body with the top surface having a continuous opening that can receive a grease trap for a pellet, charcoal or electric grill, a cutout that can receive a power cord for the grill and a tray that houses magnetic containers that can hold spices, rubs, seasonings, sauces and various other ingredients or treatments. The bottom surface of the body includes at least one continuous opening, that allows a mount to attach to the bottom surface of the body to connect the device to a boat, RV or SUV, and at least one hinge that secures a movable preparation tray or working surface. Any surface of the body may also have at least one protrusion that allows a user to hang cookware and utensils from the body. In addition, the mounting assembly may also have a magnetic surface for holding one or more utensils.

In this manner, the grill mount device of the present invention accomplishes all of the forgoing objectives and provides an improved grill mount that allows a user to easily mount an electric, charcoal or wood pellet grill to a boat, RV or SUV. Further, the device securely retains seasonings, spices, rubs, sauces and various other ingredients or treatments used while grilling on boat, RV or SUV. In addition, the device provides a workspace to allow a user to cut, trim and prepare food for grilling or cooking that can be stored underneath the device when not in use.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a grill mount device that allows a wood pellet, charcoal or electrical grill to be mounted to a boat, RV or SUV. The device has a body with a top surface of the body having an opening that can receive a grease trap for a pellet, charcoal or electric grill, a cutout that can receive a power cord for the grill and a tray. The bottom surface has at least one continuous opening that allows a mount to attach to the bottom surface in order to connect the device to a boat, RV or SUV, and at least one hinge that secures a movable preparation tray or working surface. Any surface of the body may further include at least one protrusion that allows a user to hang cookware or other utensils from the body.

The top surface has a tray that is magnetically-attached to the top surface. The tray can further hold a plurality of containers that can hold various cooking spices, rubs, seasonings, sauces and various other ingredients or treatments as well as other utensils. Each container has a metal magnetic bottom surface and a metal magnetic lid. As such, each container can be magnetically-secured to the tray, such that the containers cannot fall from the tray when a boat is in motion or rocking on a body of water, or the RV or SUV rocks during a wind or other impact or force.

The bottom surface of the body has at least one continuous opening that allows at least one fastener to be screwed into the bottom surface of a wood pellet, charcoal or electric grill. The at least one opening can be arranged in any pattern, position or orientation to correspond with any mounting structure located on the bottom surface of a wood pellet, charcoal or electric grill. The bottom surface has at least one hinge that attaches to a movable preparation tray or working surface. When not in use, the working surface can be stored in a folded position on the bottom surface of the body, or can be flipped outwards from underneath the body such that it is level with the top surface and can lock in a closed position. As a result, the top surface can be used to prepare meats, fish and other foods for grilling or cooking. Further, any mount known in the art can be secured to the bottom surface via any fastener known in the art. As a result, once a grill is secured to the device, the device can be secured to any surface of a boat, RV or SUV that the mount has been secured on.

Accordingly, the grill mount device of the present invention is particularly advantageous as it allows a user to easily secure a wood pellet, charcoal or electrical grill to a boat, RV or SUV, such that the grill remains secure. In addition, the tray ensures any spices, rubs, seasonings, sauces and various other ingredients or treatments are secured while a boat, RV or SUV is in motion or is idling. Finally, the working surface provides space for a user to easily prepare food for grilling or cooking that can be stored in an unobtrusive manner when not in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a grill mount device of the present invention in accordance with the disclosed architecture;

FIG. 2 illustrates a top perspective view of one potential embodiment of a grill mount device of the present invention in accordance with the disclosed architecture;

FIG. 3 illustrates an enhanced top perspective view of one potential embodiment of a grill mount device of the present invention in accordance with the disclosed architecture;

FIG. 4 illustrates an enhanced bottom perspective view of one potential embodiment of a grill mount device of the present invention in accordance with the disclosed architecture; and

FIG. 5 illustrates a bottom perspective view of one potential embodiment of the mounting assembly with side tray and pull out tray of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved grill mounting assembly. There also exists a long-felt need in the art for a grill mounting device that allows a user to easily mount an electric, charcoal or wood pellet grill to a boat, RV or SUV. and that securely retains spices, rubs, seasonings, sauces, and various other ingredients or treatments while grilling on boat, RV or SUV. Finally, there exists a long-felt need in the art for a grill mounting device that provides a workspace to allow a user to cut, trim and prepare food for grilling or cooking.

The present invention, in one exemplary embodiment, is comprised of a grill mounting device. The device allows a wood pellet, charcoal or electrical grill to be mounted to a boat, RV or SUV, and includes a body with a top surface having a continuous opening that can receive a grease trap of a pellet, charcoal or electric grill, a cutout that can receive a power cord for the grill when an electric grill is used and a tray. Further, the bottom surface has at least one continuous opening that allows a mount to attach to the bottom surface in order to connect the device to a boat, RV or SUV, and at least one hinge that secures a movable preparation tray or working surface. In addition, any surface of the body may further have at least one protrusion that allows a user to hang cookware or other utensils from the mounting assembly.

The top surface of the body has a tray that is magnetically-attached to the top surface. The tray can further hold a plurality of containers that can hold various cooking spices, rubs, seasonings, sauces and various other ingredients or treatments, with each container having a metal magnetic bottom surface and a metal magnetic lid. Therefore, each container can be magnetically-secured to the tray, such that the containers cannot fall from the tray when a boat is in motion or rocking on a body of water or when an RV or other vehicle, such as a SUV, is moving.

The bottom surface of the body has at least one continuous opening that allows at least one fastener to be screwed or inserted into the bottom surface of a wood pellet, charcoal or electric grill. The at least one opening can be arranged in any pattern, position or orientation to correspond with any mounting structure located on the bottom surface of a wood pellet, charcoal or electric grill. The bottom surface also has at least one hinge that attaches to a movable preparation tray or auxiliary working surface. When not in use, the surface can be stored in a folded position on the bottom surface of the body. When in the open position, the surface can be flipped outwards from underneath the body, such that it is level with the top surface and can locked in position. The top surface can then be used to prepare meats, fish and other foods for grilling or cooking. Further, any mount known in the art can be secured to the bottom surface via any fastener known in the art. As a result, once a grill is secured to the device, the device can be secured to any surface of a boat, RV or SUV on which the mount has been secured.

Accordingly, the grill mounting device of the present invention is particularly advantageous as it allows a user to easily secure a wood pellet, charcoal or electrical grill to a boat, RV or SUV, such that the grill remains secured to the surface. In addition, the tray or surface ensures any spices or seasonings are secured while the boat, RV or SUV is in motion or is idling. Finally, the working surface or tray provides space for a user to easily prepare food for grilling or cooking that can be stored in an unobtrusive manner when not in use.

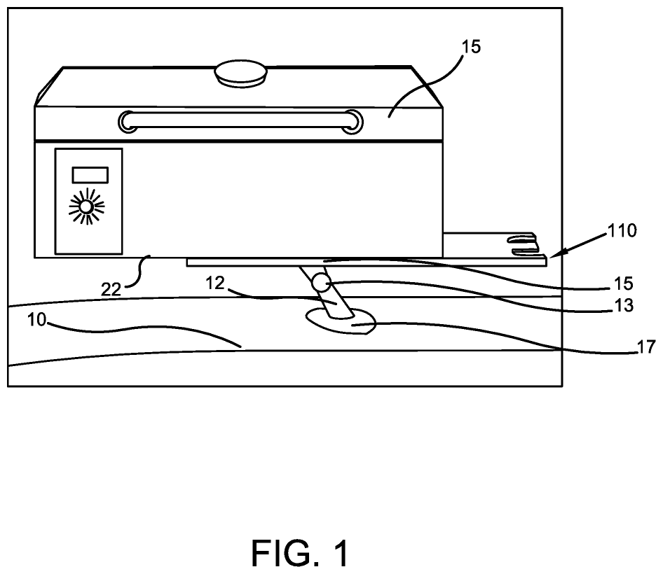

Referring initially to the drawings, FIG. 1 illustrates a front perspective view of one potential embodiment of a grill mount device 100 of the present invention in accordance with the disclosed structure. The device 100 has a body 110 with a top surface 120, two sets of generally parallel side surfaces 150 and a bottom surface 140. The top surface 120 has a continuous opening 122 that can receive a grease trap 24 for a pellet, charcoal or electric grill 20, a cutout 124 that can receive a power cord 26 for the electric grill 20 and a shelf or caddy 130. The bottom surface 140 has at least one continuous opening 142 that allows a mounting arm 12, which has first and second ends 15, 17, with the first end connected to the bottom of the grill and the second end to the boat, RV or SUV, to attach to the bottom surface 140 and connect the device 100 to a surface of a boat, RV or SUV 10, and at least one hinge 144 that secures a movable preparation tray or working surface 146. The mount 12 is an extensible arm that may allow the user of the grill to move the grill to a position to accommodate the height of a particular individual. The mounting arm 12 connects to the base or bottom of the body of the grill mounting assembly. The mounting arm 12 may also include a ball or swivel joint 13 to allow the grill to be moved to different positions for cooking.

In differing embodiments, the body 110 may be any shape known in the art such as rectangular, square, circular, trapezoidal or any other fanciful shape and may be of any necessary size in order to sufficiently support the weight of a wood pellet, charcoal or electric grill 20. The body 110 is manufactured from a durable metal such as, but not limited to, stainless steel or aluminum. In addition, the body 110 may have a waterproof, rust-proof coating and/or salt-water proof coating.

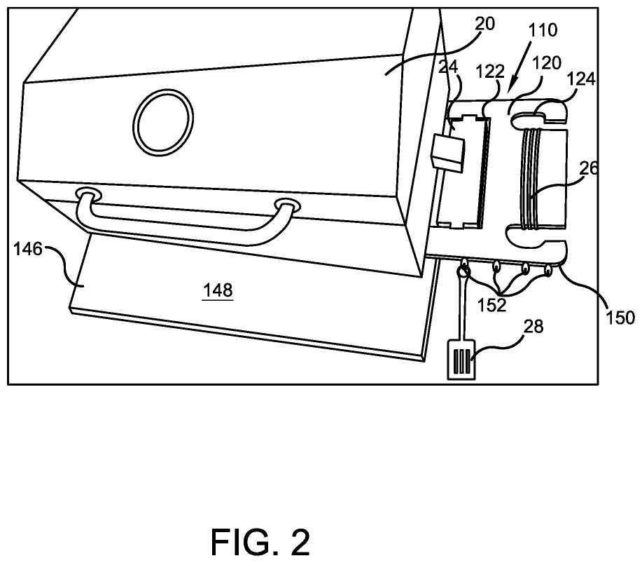

FIG. 2 illustrates a top perspective view of one potential embodiment of a grill mounting device 100 of the present invention in accordance with the disclosed specification. In the preferred embodiment, the size of the body 110 is larger than the overall footprint of the grill 20 to which the mounting assembly 100 is attached. The top surface 120 of the body 110 has at least one continuous opening 122 that can receive a grease trap 24 for a wood pellet, charcoal or/electric grill 20. The trap 24 can be placed inside the opening 122. The top surface 120 has a cutout 124 that can receive a power cord 26 for an electric grill 20, such that the cord 26 can be wrapped around the cutout 124 when not in use. Any surface 120, 140, 150 of the body 110 may further have at least one protrusion 152 that allows a user to hang cookware or other utensils 28, such as but not limited to: spatulas, knives, spoons, forks or combinations thereof from the body 110.

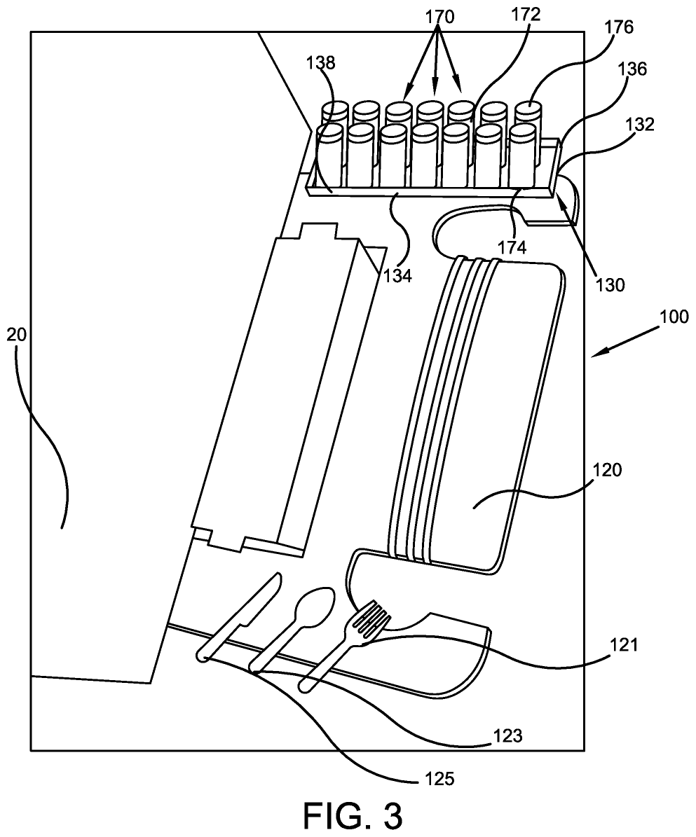

FIG. 3 illustrates an enhanced top perspective view of one potential embodiment of a grill mounting device 100 of the present invention in accordance with the disclosed structure. The top surface 120 has a shelf or caddy 130 that magnetically attaches to the top surface 120. The shelf or caddy 130 has two side surfaces 132, a bottom surface 134, a rear surface 136 and a front surface 138. The shelf or caddy 130 is manufactured from a durable magnetic metal, such as but not limited to stainless steel or aluminum. The shelf or caddy tray 130 can further hold a plurality of containers 170 that can hold various cooking seasonings, spices, rubs, sauces and various other ingredients or treatments. Each container 170 body 172 has a metal magnetic bottom surface 174 and a metal magnetic lid 176. In this manner, each container 170 can be magnetically-secured to the shelf or caddy 130, such that the containers 170 cannot fall from the tray 170 when a boat, RV or SUV 10 is in motion or rocking, such as a boat on a body of water. Additional cooking utensils 121, 123 and 125 can be mounted to the tray 120 by magnets or other fastening assemblies, such as snap connects or the like.

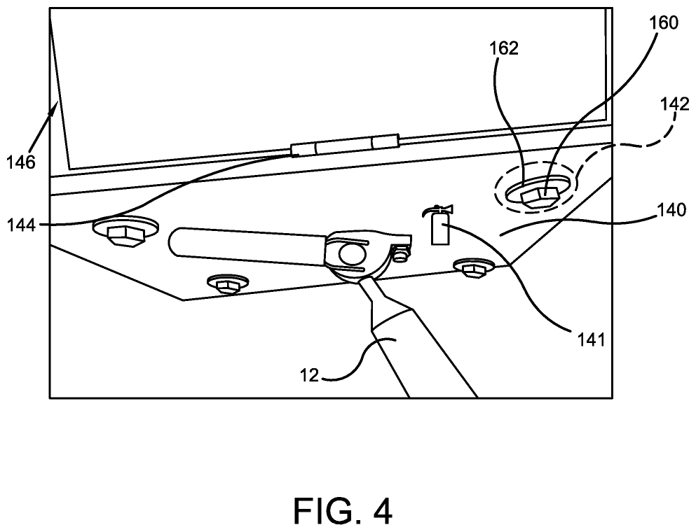

FIG. 4 illustrates an enhanced bottom perspective view of one potential embodiment of a grill mount device 100 of the present invention in accordance with the disclosed specification. The bottom surface 140 of the body 110 has at least one continuous opening 142 that allows at least one fastener 160 and at least one washer 162 to be screwed into the bottom surface 22 of a wood pellet, charcoal or electric grill 20. In differing embodiments, the at least one fastener 160 may be a bolt, screw or other fastener of the like. It should be appreciated that the at least one opening 142 can be arranged in any pattern, position or orientation to correspond with any mounting structure located on the bottom surface 22 of a wood pellet, charcoal or electric grill 20. The mounting assembly may also include a fire extinguisher 141 to extinguish any flames or fire that may have started inadvertently.

The bottom surface 140 has at least one hinge 144. In differing embodiments, the at least one hinge 144 may be any hinge-type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The at least one hinge 144 further attaches to a movable preparation tray or working surface 146. When not in use, the surface 146 can be stored in a first or folded position on the bottom surface 140 of the body 110. When desired for use, the surface 146 can be flipped outwards to a second position from underneath the body 110, such that it is level with the top surface 120 and can be locked in position to provide for a preparation or holding surface. As a result, the top surface 148 of the tray 146 can be used to prepare a plurality of meats, fish and other foods for grilling or cooking. In addition, any mounting arm 12 known in the art can be secured to the bottom surface 134 via any fastener known in the art. As a result, once a grill 20 is secured to the device 100, the device 100 can be secured to any surface of a boat, RV or SUV 10 on which the mount 12 may be secured.

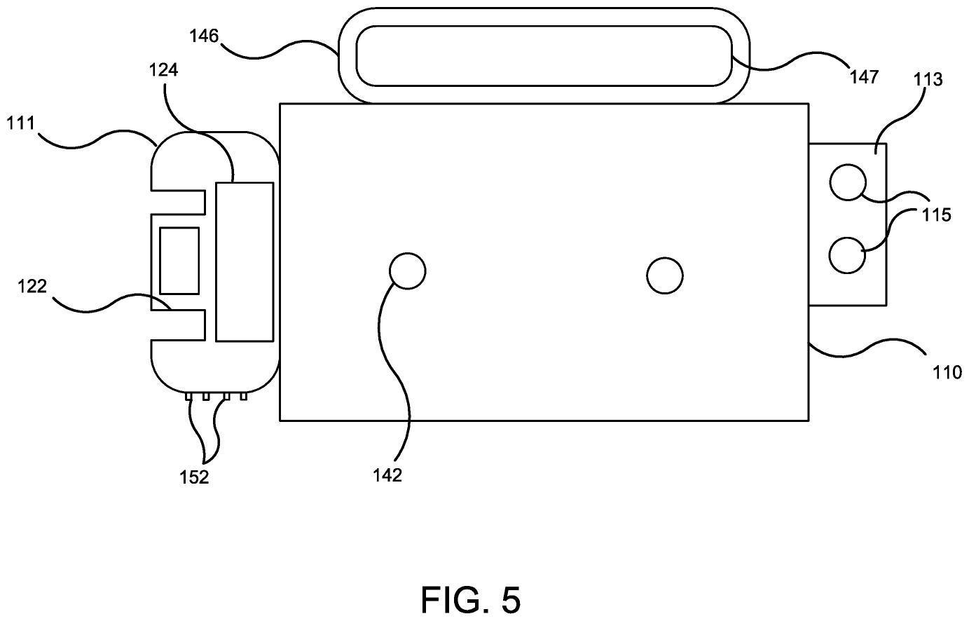

FIG. 5 shows the underside of the mounting structure 110 with side extension area 111 which forms part of the main body structure 110. The side extension has two openings 122 and 124, which serve as the opening for the grease tray and cord wrap area where the grill is an electric grill. The side extension 111 has projections 152 for holding cooking accessories or utensils. The mounting structure 110 has a pull-out tray 146 for cooling and preparations. The pull-out tray may also have a removable cutting surface 147 for ease of clean up. The mounting structure 110 may also include a second extension tray 113, having first and second cup holders 115, so that the individual cooking may have a beverage or use the holders for any other item which may fit in the openings. The first extension and second extension are opposite one another on the mounting assembly. The mounting structure 110 is held to a surface of a boat, RV or SUV by fasteners inserted through the openings 142.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “grill mount or mounting device” and “device” are interchangeable and refer to the grill mount device 100 of the present invention.

Notwithstanding the forgoing, the grill mount or mounting device 100 of the present invention and its various components can be of any suitable size and configuration as is known in the art without affecting the overall concept of the invention, provided that they accomplish the above-stated objectives. One of ordinary skill in the art will appreciate that the size, configuration and material of the grill mount or mounting device 100 as shown in the FIGS. are for illustrative purposes only, and that many other sizes and shapes of the grill mount or mounting device 100 are well within the scope of the present disclosure. Although the dimensions of the grill mount or mounting device 100 are important design parameters for user convenience, the grill mount or mounting device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A grill mounting assembly comprising:
a body having a top and a bottom surface and a pair of side edges;
a mounting arm connected to the bottom surface of the body and to a surface of one of a RV, a boat or a vehicle; and
a preparation surface connected to the body and movable from a first position to a second position, wherein the preparation surface is hingedly connected to the body.

2. The grill mounting assembly as recited in claim 1, wherein the first position is a folded position and the second position is an open unfolded position.

3. The grill mounting assembly as recited in claim 1, wherein the body comprises at least one opening to connect a grill to the body.

4. The grill mounting assembly as recited in claim 1, wherein the body is comprised of a magnetic portion.

5. The grill mounting assembly as recited in claim 4 further comprising at least one of a container, a shelf or a utensil magnetically attached to the magnetic portion.

6. The grill mounting assembly as recited in claim 4 further comprising a fire extinguisher attached to the body.

7. The grill mounting assembly as recited in claim 1, wherein the body comprises a first extension having at least one opening therein.

8. The grill mounting assembly as recited in claim 7, wherein the body comprises a second extension on an opposite side from the first extension, and the second extension comprises at least one opening.

9. The grill mounting assembly as recited in claim 7, wherein the body comprises a shelf attached to the first extension for holding at least one of a seasoning, a spice, a rub, a sauce, an ingredient or treatment, or a combination thereof.

10. The grill mounting assembly as recited in claim 1, wherein the mounting arm comprises a ball or swivel joint to allow the body to articulate in relation thereto.

11. A grill mounting assembly and grill combination comprising:
a grill comprising a bottom surface and at least one opening;
a mounting assembly comprising a mounting arm for connecting the mounting assembly to one of a boat, a vehicle or an RV, a body with at least one opening for insertion of a fastener through the at least one opening and through the at least one opening in the grill bottom surface to attach the grill to the mounting assembly; and
at least one side extension positioned adjacent to the body, wherein the at least one side extension is comprised of a first opening, a second opening and a series of projections for holding a plurality of accessories.

12. The grill mounting assembly and grill combination as recited in claim 11, wherein the mounting assembly further comprises a preparation surface repositionable between a first position and a second position and hingedly connected to the mounting assembly.

13. The grill mounting assembly and grill combination as recited in claim 12, wherein the first position is an open position and the second position is a closed position.

14. The grill mounting assembly and grill combination as recited in claim 11, wherein one of the first and second openings in the side extension is for holding a grease trap.

15. The grill mounting assembly and grill combination as recited in claim 11, wherein the mounting body is comprised of a second side extension positioned opposite the at least one side extension, and further wherein the second extension comprises at least one opening sized and configured as a cup holder.

16. The grill mounting assembly and grill combination as recited in claim 11, wherein the mounting assembly further comprises a shelf disposed on the at least one side extension, and further wherein the shelf is sized and configured for holding at least one of a seasoning, a spice, a rub, a sauce, an ingredient or treatment, or a combinations thereof.

17. The grill mounting assembly and grill combination as recited in claim 11, wherein the mounting arm comprises a ball or swivel joint.

18. The grill mounting assembly and grill combination as recited in claim 16, wherein the shelf is magnetically attached to the at least one side extension.

19. A mounting body for holding a grill, the mounting body comprising:
a body having a top and bottom surface with the top surface connected to a bottom surface of a grill and a mounting arm having first and second end with the first end connected to the bottom surface of the body and the second surface to one of a boat, RV or SUV,
at least one side extension extending outwardly from the body and the at least one side extension having at least one opening for holding a grill trap; and
a shelf attached to the at least one side extension and the shelf sized and configured to fit at least one of one of seasonings, spices, rubs, sauces, other ingredients or treatments, or combinations thereof and the at least one the seasonings, spices, rubs, sauces, other ingredients or treatments, or combinations thereof held to the shelf by a magnet.

20. The mounting body for holding a grill as recited in claim 19, wherein the body comprises a second side extension in a position opposite from the at least one side extension and the second side extension is comprised of at least one opening for receiving a beverage container.
